(19) United States
(12) Patent Application Publication
(10) Pub. No.: US 2016/0181837 A1
(43) Pub. Date: Jun. 23, 2016

(54) HYBRID BATTERY BALANCING SYSTEM

(71) Applicant: Ying-Haw SHU, Taipei (TW)

(72) Inventor: Ying-Haw SHU, Taipei (TW)

(21) Appl. No.: 15/056,018

(22) Filed: Feb. 29, 2016

Related U.S. Application Data
(63) Continuation-in-part of application No. 13/897,099, filed on May 17, 2013.

(51) Int. Cl. H02J 7/00

(52) U.S. Cl. CPC H02J 7/0014; H02J 7/0072

(57) ABSTRACT

A hybrid battery balancing system coupled to a battery pack protection system having a main control processor is provided. The hybrid battery balancing system includes a cell voltage/temperature and bypassing module, multiple independent battery chargers and a battery pack with multiple battery cells in serial connection and connected between the battery charger and the cell-voltage/temperature and bypassing module in a cascaded fashion. The cell voltage/temperature and bypassing module includes a cell-voltage and temperature module and a plurality of bypassing equalizers built within the cell voltage and temperature module, which read cell voltage and temperature information and upload the cell voltage and temperature information to the main control processor, and receive a balance instruction returned by the main control processor to control a bypass current for facilitating a passive control. The independent battery chargers are coupled with the bypassing equalizers to enhance the equivalent balancing capacity of bypassing equalizers.

### CROSS-REFERENCE TO RELATED APPLICATIONS

This application is a continuation in part application of U.S. patent application Ser. No. 13/897,099, filed on May 17, 2013, the entire contents of which are hereby incorporated by reference.

### FIELD

The instant disclosure relates to a hybrid battery balancing system, and more particularly to a hybrid battery balancing system incorporating both active balancing and bypass balancing structures for meeting the demands of large-scale battery packs requiring effective balancing currents and balancing capacitance in quick charge.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In general lithium, manganese, cobalt, and nickel-based batteries (Li—Mn—Co—NiO2), the appearing cell voltages effectively reflect the state of charge (SOC) of the batteries. Even so, the voltage difference among the battery cells arising out of the difference in their characteristics would have negative impact on the rule of battery SOC determination depending on the cell voltage. As shown in FIG. 1, when the lithium, manganese, cobalt, nickel-based batteries are charged or discharged at 0.5 charging and discharging rate, both of which indicate the charging and discharging current divided by the nominal ampere-hour, respectively. Specifically, the battery charged from 85% or 90% to 100% in SOC may take 50% of the overall battery charging time, which is a critical characteristic in the battery balancing, but not desirable when it comes to the quick battery charge.

FIG. 2 shows the time-varying cell voltage of a conventional lithium iron phosphate (LiFePO₄) operating at 0.5 charging and discharging rate. It is shown in FIG. 2 that the charging and discharging curves of such battery are associated with longer “flat” zone, and the rapid rise and fall only take place at the end of the discharging and charging. Any mechanism aiming for balancing the lithium iron phosphate batteries could be challenged since the reading of the cell voltage needs precise calibration during the flat range, and the difference in battery structure or material purity in the manufacturing process could lead to the variation of the cell voltage. Both of those two issues could attribute to erroneous SOC determination on the cell voltage. Besides, the voltage variation happening in the last 0.3%-0.8% section of the battery charging time is too large, and that time period for the SOC/battery balancing is too short to achieve the goal of the SOC balancing.

The SOC balancing is generally handled by balancing circuits such as passive/bypassing equalizer and active equalizer. Advantages of the active equalizer include (1) effectively preventing the continuing rise of the cell voltages of the serial battery cells from the over-voltage protection to extend the charging time of the whole battery pack, therefore, effectively increasing the available service-capacity range in the quick charge, (2) in the discharging process transferring the electrical energy from battery cell with the larger SOC to the battery cell with the lesser SOC to effectively enhance discharging capacity of the whole battery pack when significant difference exists between the battery cells in their SOC, and (3) increasing the potential ampere-hours could be used as the larger balancing current is used for the battery pack having a single cell with a larger SOC in the discharging process. However, the disadvantages of the active equalizer include (1) shortening the service life-cycles of the batteries because of the rapid charging and discharging taking place during the active balancing, especially for the floating-charge stage in which the battery is charged at a fixed charging voltage, (2) increased possibility of erroneous reading of cell voltages because of the rapid charging and discharging (since the cell voltage is the result of electrochemical equilibrium, or the cell voltage takes some time to be stable after being disturbed), interfering the balancing decision, and further shortening the service life-cycles of the batteries, (3) undesirable efficiency in balancing the cell with the lower SOC with the balancing current (for example, the equivalent additionally charging current may be less than 250 mA for the lower-SOC battery cell within 12 battery cells in serial connection as applied the active equalizer with the maximum balancing current up to 5 amperes), and (4) costing too much to get the expected balancing result.

On the other hand, advantages of the passive balancing include (1) by providing a bypassing circuitry for partially charging the battery cell having the largest SOC during the same charging period in order to get the SOC balance of the battery cells (rather than discharging the battery cell with the largest SOC, which may shorten the service life-cycle of the same), (2) simplifying the design of the balancing circuitry without fast discharging then charging circuitry between battery cells, (3) less reading interference of the cell voltage due to minimized occurrence of the electric-charge accumulation on the electric polar of battery cell, (4) the SOC discrepancy between the battery modules, which is handled by different balancing controllers, becoming under control, which is suitable for large-scale battery pack, (5) eliminating the continuous but useless charging and discharging of the battery pack which is almost applied in floating charge for such as uninterruptible power system (UPS), thus maintaining the service life-cycle of the battery pack, and (6) being able to warm up the whole battery pack as activating the passive equalizer widely adopted in solar ESS (energy storage system) in the freezing areas.

Disadvantages of the passive balancing include: (1) more power consumption because of the presence of the charging bypass circuit, and lowering the charging efficiency and generating additional heat, which may lead to another challenge to the maintaining of the service life-cycle of battery pack, therefore, suggest having the balancing current restriction in the passive equalizer, (2) limitation on the power consumption associated with the bypassing current in the bypass circuit, (3) limitation on self leakage of the battery cell (otherwise, the balancing current for the periodically charged battery pack may not be equalized even after one or multiple charging/discharging cycles) or necessity of pre or post-balancing to enhance the balancing performance in one single charging cycle, though the post-balancing may not be suitable for the lithium iron phosphate battery cells because of their flat zone, and (4) inferior charging efficiency.

Additionally, another equalizer circuit having multiple battery chargers with their output isolated from each other, each of which is adapted to independently charge its corresponding battery cell, has been developed. Since the charging process for each battery cell is controlled by the corresponding battery charger, it is possible that each battery cell gets fully charged in the first charge cycle. As such, the advantages of this equalizer include: avoiding the use of complicated control system, accommodating more significant SOC discrepancy between the battery cells, and suffering no problem associated with the transfer of the electrical energy between the battery cells. Since the battery chargers here have their input terminals connected to the same power supply in parallel and their output terminals are independently and serially connected to the battery cells, the either AC or DC electrical power is delivered to the battery cells. Therefore, the disadvantages of this equalizer may include: (1) requiring additional wiring within the battery cells, complicating the design and increasing the risk of the operation of the battery pack, (2) external connecting points of the battery-cell wires being sensitive to EMI/ESD (Electromagnetic Interference/ElectroStatic Discharge) impact and thus affecting the EMC (electromagnetic compatibility) tolerance level of the whole battery pack, (3) higher cost for this type with the multiple high-current and low-voltage battery chargers, and lowered conversion efficiency, both of which are unfavorable for the promotion of such equalizer, and (4) as incorporated into large-scale battery systems increasing the difficulty in terms of wiring issue.

Therefore, the equalizer composed of high SOC adjustability in the active equalizers or the equalizers having multiple independent battery chargers and charging-current adjustment without energy transfer between the battery cells in the bypassing equalizer could effectively eliminate the discrepancy in the battery SOC, satisfy the need of the quick charge, and will be the best solution for battery balance.

The referenced Patent No. U.S. Pat. No. 6,014,013 (hereinafter the '013 Patent) teaches a sort of modified multiple balance-chargers. The '013 Patent replaces the manually switching operation with electronic switch under center control system, and provides two levels of charging current, in FIG. 2 of the '013 Patent, bypassing module depended on cell temperature, and its bypassing module/current switch is a part of balance charger, and that is described in the '013 Patent. Simply speaking, the advantages of the '013 Patent are human safety and free from thermal-run-away issue. However, the disadvantages of the '013 Patent is still same as the traditional one in the EMC and wiring issue. Although there is central control unit and bypassing switches for charging-current level, it is clear that the '013 Patent is still an application of modified multiple balance chargers.

The reference Patent Publication No. U.S. 2014/0009092 (hereinafter the '092 Publication) reveals a possible composed balance scheme with two different equalizing circuits, which are the bypassing equalizer and a fly-back converter/charger with multi-outputs. Of course, the number of outputs defines the possible cost of such fly-back converter/charger. In the '092 Publication, the fly-back converter/charger only takes care the balance between cell groups, and reserves the cell balance in a cell group to the bypassing equalizer. However, such composed hybrid equalizer still can't avoid the disadvantage of useless charging and then discharging process, and that wastages valuable the life-cycle of the whole battery pack. Even in its second embodiment, the fly-back converter/charger is powered by an external power supply, the cell group of V2 is charged by such external power supply, not other battery cells, the cell groups of V1 and V3 are still discharged by the internal bypassing equalizer shown in its FIG. 8. The cell group of V2 is also charged over the balance target, and then discharged back by the internal bypassing equalizer of V2. That is because its charger with multi-outputs is specific to cell group, not to each cell, and that cannot avoid other cells over-charged in the cell group with the smallest SOC cell. Such equalizing scheme may be still harmful to battery life during the floating-charge process since there are many cells will be sinless charged and discharged till the lowest cell match the final equalizing target.

Therefore, an unaddressed need exists in the art to address the aforementioned deficiencies and inadequacies.

### SUMMARY

An equalizer composed of (1) high SOC adjustability in the active equalizers or the equalizers having multiple independent battery chargers, (2) charging-current adjustment without energy transfer between the battery cells and useless charge and discharge in the bypassing equalizer, and (3) high discrepancy elimination in the battery SOC satisfies the need of the quick charge, and will be the best solution for battery balance.

In one aspect, a hybrid battery balancing system coupled to a battery pack protection system having a main control processor is provided. The battery balancing system includes: a cell voltage/temperature and bypassing module; a plurality of battery chargers coupled to the cell voltage/temperature module; and a battery pack with a plurality of battery cells in serial connection and connected between the battery chargers and the cell voltage/temperature and bypassing module in a cascaded manner. The cell voltage/temperature and bypassing module includes a cell voltage and temperature module and a plurality of bypassing equalizers built within the cell voltage and temperature module. In certain embodiments, the cell voltage/temperature and bypassing module is configured to: read cell voltage and temperature information; upload the cell voltage and temperature information to the main control processor; and receive a balance instruction from the main control processor to control a bypass current for facilitating a passive control, wherein the main control processor is configured to generate the balance instruction based on the uploaded cell voltage and temperature information and return the balance instruction to the cell voltage/temperature and bypassing module. The battery cells are connected to the battery charger and the bypassing equalizers.

In certain embodiments, an output current of each of the battery chargers is adjusted based on the output voltage of the battery charger. In certain embodiments, the battery chargers are powered by an external main charger or alternating current (AC) source and not by electrical energy from the battery cells; and the battery chargers are configured to provide currents required for balancing a state of charge (SOC) of the battery cells.

In certain embodiments, a bypassing function of cell voltage/temperature and bypassing module is instructed to operate by the main control processor.

In certain embodiments, the battery chargers include a plurality of independent chargers, and are configured to be activated by the main control processor.

In certain embodiments, each of the battery chargers is configured to be operated by the cell voltage/temperature and bypassing module to provide a reverse function of the corresponding bypassing equalizer, and to stop the corresponding battery cell when the corresponding bypassing equalizer turns on a bypassing switch.

In certain embodiments, the battery chargers are only in operation when the external main charger is activated, and a current capacity of the external main charger is greater than current capacities of the battery chargers.

In certain embodiments, for each of the battery chargers, an output current is limited to be smaller than a maximum current, and a charging voltage for the battery cell corresponding to the battery charger is greater than a rated charging voltage

These and other aspects of the instant disclosure will become apparent from the following description of the preferred embodiment taken in conjunction with the following drawings, although variations and modifications therein may be effected without departing from the spirit and scope of the novel concepts of the disclosure. In order to further the understanding regarding the instant disclosure, the following embodiments are provided along with illustrations to facilitate the disclosure of the instant disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows charging/discharging curves for a lithium, manganese, cobalt, and nickel-based battery;

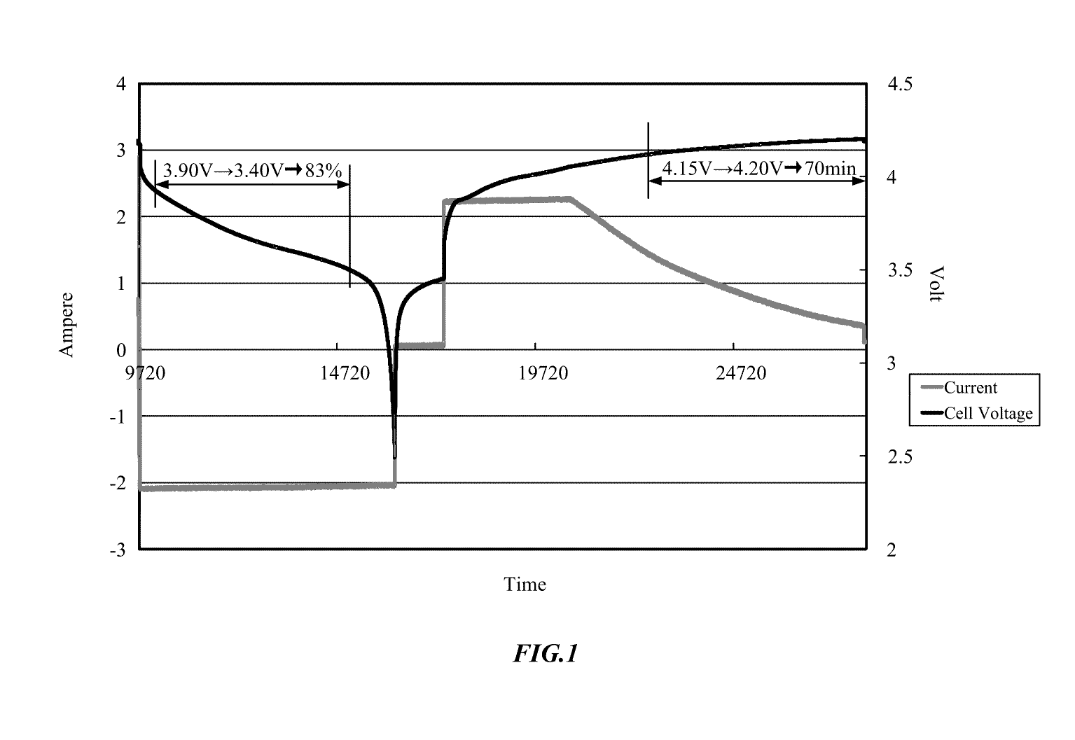

FIG. 2 shows charging/discharging curves for a conventional lithium iron phosphate battery;

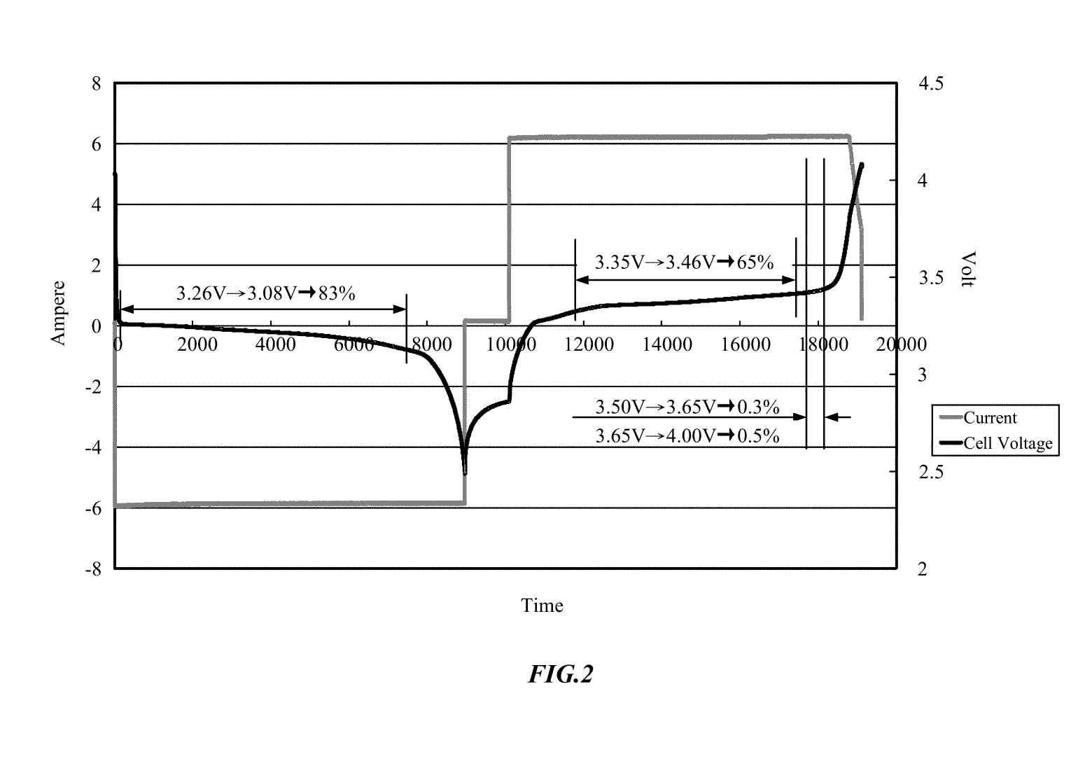

FIG. 3 shows a schematic diagram of a hybrid battery balancing system according to one embodiment of the instant disclosure;

FIG. 4 shows the variation relationship between the charging current and the charging voltage of the battery charger when one of the preferred adjusting approaches is adopted;

FIG. 5 shows a hybrid battery balancing system according to one embodiment of the instant disclosure;

FIG. 6 shows an experiment result for the system in FIG. 5 according to one embodiment of the instant disclosure;

FIG. 7 shows another experiment result of the system in FIG. 5 according to one embodiment of the instant disclosure;

FIG. 8 is another hybrid battery balancing system according to one embodiment of the instant disclosure;

FIG. 9 is another hybrid battery balancing system according to one embodiment of the instant disclosure; and

FIG. 10 shows the experiment result of the embodiment in FIG. 9.

### DETAILED DESCRIPTION OF THE EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

As used in the description herein and throughout the claims that follow, the meaning of “a”, “an”, and “the” includes plural reference unless the context clearly dictates otherwise. Moreover, titles or subtitles may be used in the specification for the convenience of a reader, which shall have no influence on the scope of the present invention.

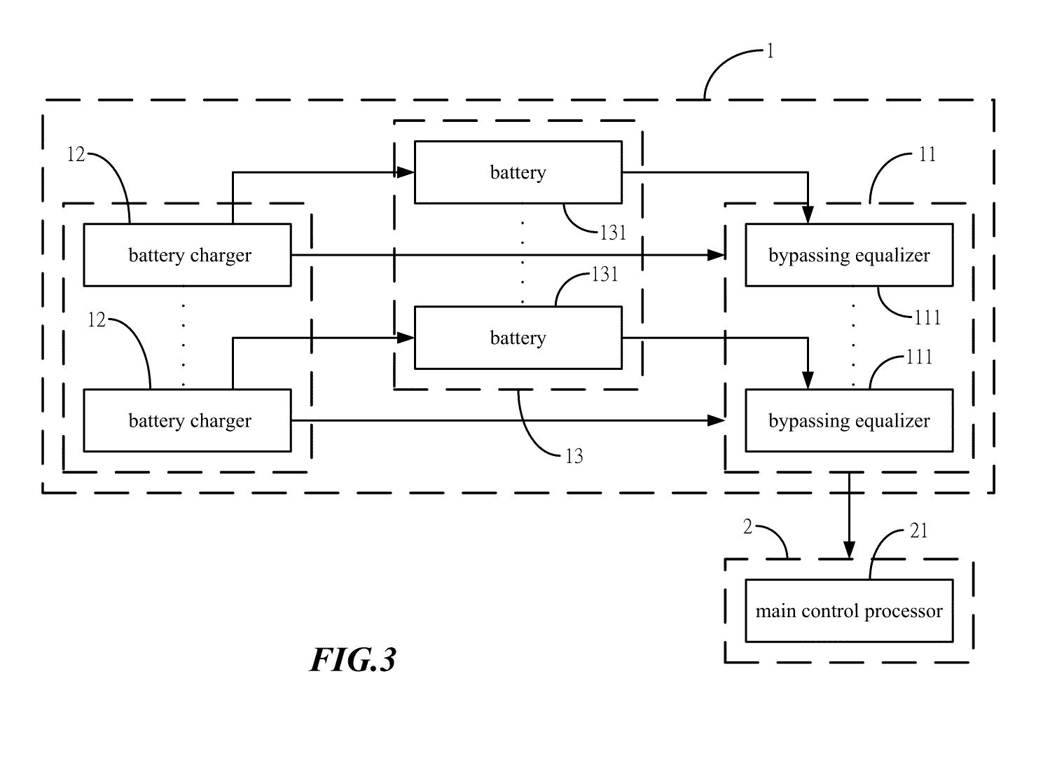

Please refer to FIG. 3 showing a schematic diagram of a hybrid battery balancing system 1 according to one embodiment of the instant disclosure. The hybrid battery balancing system 1 is coupled to a battery pack protection system 2 having a main control processor 21. The hybrid battery balancing system 1 may further include a cell voltage/temperature and bypassing modules 11, multiple battery chargers 12 and a battery pack 13. In one embodiment, the cell voltage/temperature and bypassing module 11 includes a plurality of bypassing equalizers 111, which may be built within a traditional cell voltage and temperature modules to form the cell voltage/temperature and bypassing module 11. The batteries 131 of the battery pack 13 may be connected in a cascaded manner, and may be connected between the battery charger 12 and the cell voltage/temperature and bypassing module 11. In certain embodiments, each of the battery cells 131 of the battery pack 13 is one-by-one connected to one of the battery chargers 12 and one of the bypassing equalizers 111, such that each of the battery cells 131 is charged by the corresponding battery charger 12 being connected thereto.

In certain embodiments, the cell voltage/temperature and bypassing module 11 is configured to read cell voltage and temperature information, and upload the cell voltage and temperature information to the main control processor 21. The main control processor 21 may, based on the uploaded cell voltage and temperature information, generate a balance instruction, and return the balance instruction to the cell voltage/temperature and bypassing module 11 to control a bypassing switch of the cell voltage/temperature and bypassing module 11. Since the output current of the battery charger 12 may be adjustable as well as the output voltage thereof, each of the batteries 131 may be charged by its corresponding charging current based on its required voltage and state of charge (SOC).

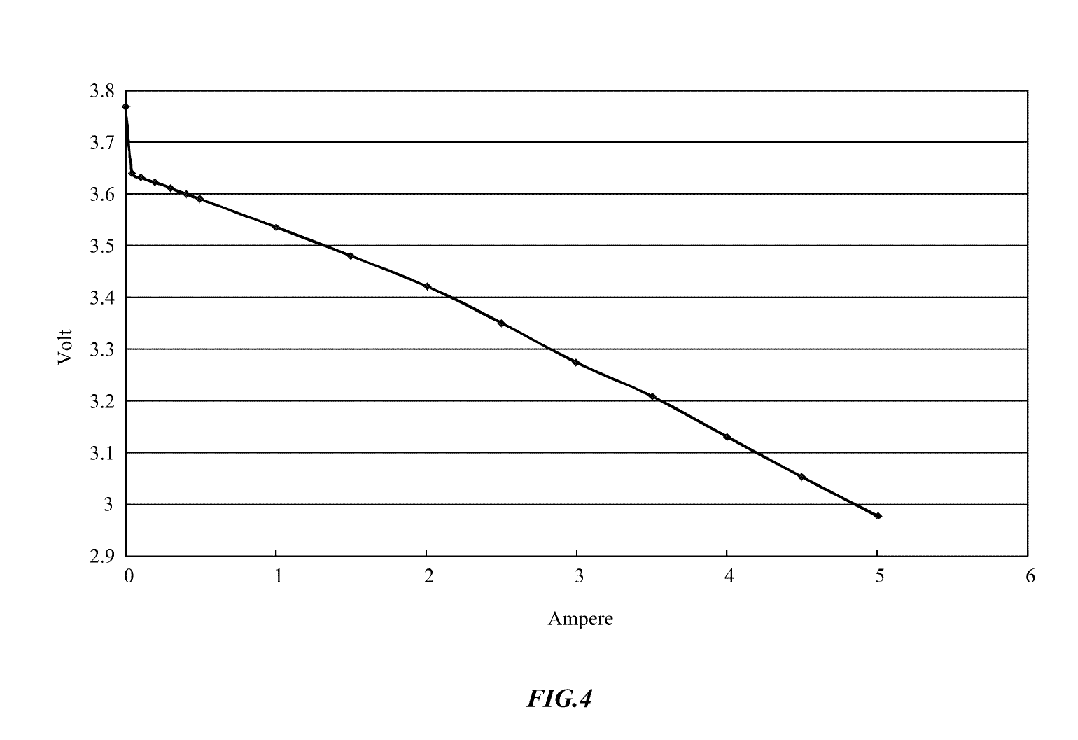

Differences between the battery cells in the instant disclosure and the conventional one may include the charging current comes from the independent battery charger 12 as well as the output current of the external main battery charger, and the output current of the independent battery chargers will decrease over the course of its output voltage. FIG. 4 shows the variation relationship between the charging current and the charging voltage of the battery charger. Thus, the output current of the independent battery charger is adjustable on basis of the cell voltage and that helps the bypassing equalizer improve its performance in effectively adjusting the charging current without generating excessive heat.

FIG. 4 illustrates the variation relationship between the charging current and the charging voltage of the battery charger when one of the preferred adjusting approaches is adopted. The charging current may be supplied by the battery charger 12 when the cell voltage exceeds 3.0 volts. The charging current may be reduced when the cell voltage continues to rise. For example, the charging current may be lowered to less than 100 mA when the cell voltage is at 3.65 volts as applied into lithium iron phosphate battery. Consequently, for each of the battery chargers, an output current is limited to be smaller than a maximum current, and a charging voltage for the battery cell corresponding to the battery charger is greater than a rated charging voltage. Also, it could be inferred from FIG. 4 that when the cell voltage is at the range from 3.50 volts and 3.65 volts, which is critical to the battery charging of a lithium iron phosphate battery, the swing of the output current of the battery charger 12 could be as large as 1.0 ampere. With this arrangement, in the advanced stage of the battery charging for the lithium iron phosphate battery the cell voltage of the lesser SOC may be provided with the larger electrical energy, increasing the cell voltage of the same battery 131 more promptly. Since the output voltage of the battery charger may remain steady throughout the course of the battery charging of all batteries 131, when the battery cell with the lesser

SOC enjoys the larger charging current from the battery charger 12, and the battery cell with the larger SOC may receive the lesser charging current from the battery charger, restraining the rise of the cell voltage of the battery larger in SOC and effectively improving the efficiency of the battery equalization.

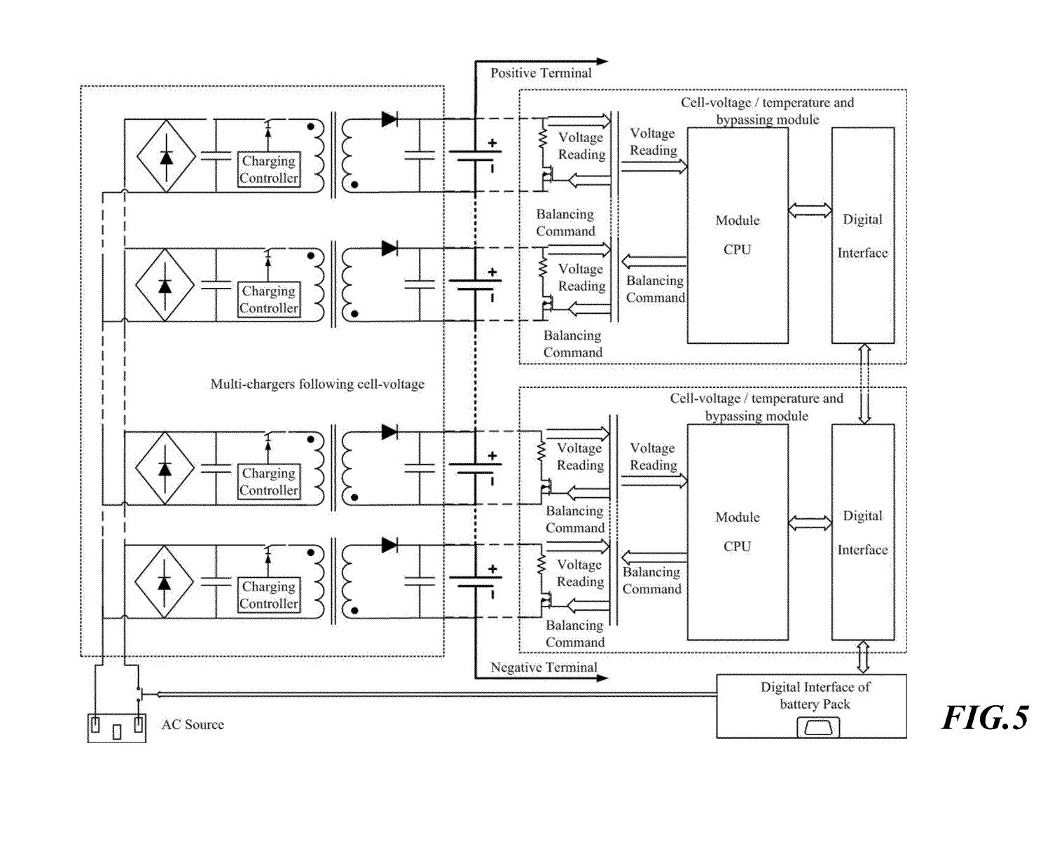

FIG. 5 shows a hybrid battery balancing system according to one embodiment of the instant disclosure. The embodiment in FIG. 5 is directed to a hybrid structure consisted of multiple battery chargers adapted to adjust their output currents based on their output voltages. As shown in FIG. 5, multiple cell voltage/temperature and bypassing modules are on the right side and they are for reading the cell voltage and the temperature in terms of analog signal, before converting the retrieved analog signals to their corresponding digital counterparts and uploading the digital signals to the main control processor of a battery pack protection system. The bypassing equalizer meanwhile may determine a bypassing behavior associated with the operation of the passive balancing based on historical data and balance instructions returned from the main control processor of the battery pack protection system.

On the left side of the structure shown in FIG. 5 are multiple battery chargers. It is worth noting that the multiple battery chargers in FIG. 5 may be similar to the battery chargers in FIG. 4 in their characteristics. In other words, the output current of the battery charger in FIG. 5 may be adjusted based on the output voltage of the battery charger, and the extent of the output current and voltage being adjusted may be according to the types of batteries, the size of the battery pack, the maximum current supply of the external battery charger, and the balancing algorithm dictating the operation of the main control processor in the battery pack protection system. In this embodiment, the cell-voltage/temperature and bypassing module does not involve the operation of the multiple battery chargers. Rather, the main control processor may determine when the multiple battery chargers are activated, at least as all battery cell-voltages matching the working range of the multiple battery chargers, and the controllable multiple battery chargers are powered by external alternating current power sources such as an AC power source in FIG. 5. In the first embodiment, the activated switch of multiple battery chargers and bypassing function is under the control of the main control process. The possible working status of this embodiment may be the pure bypassing mode, pure multiple battery chargers, and the hybrid mode.

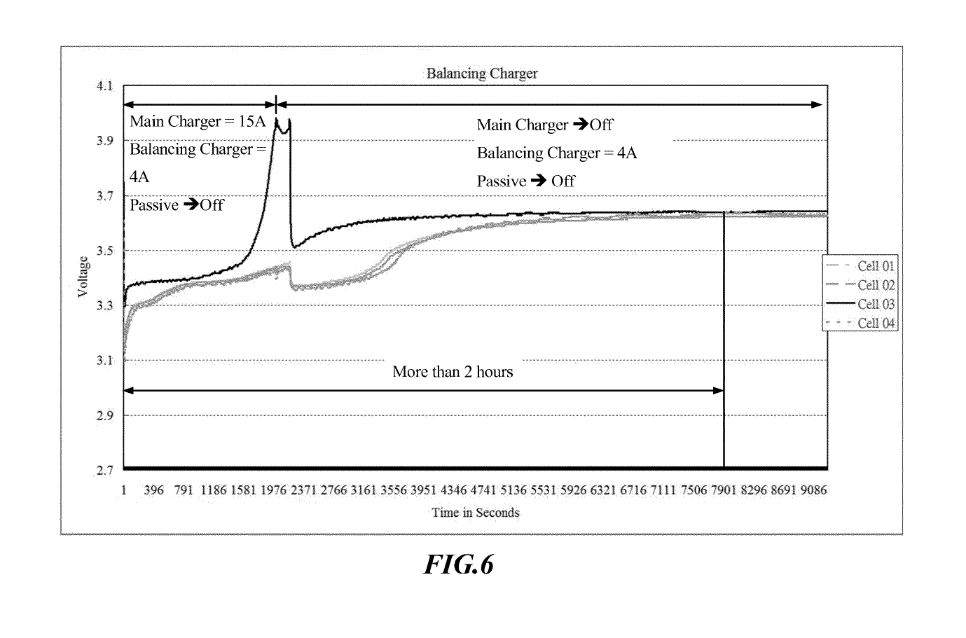

FIG. 6 shows an experiment result for the system in FIG. 5 according to one embodiment of the instant disclosure. The battery pack employed 16 serial battery cells connected in a cascaded fashion with each of the batteries 28.8 Ah (2% tolerance) in SOC. Additionally, the multiple battery chargers used for this experiment may be used to adjust their output currents on basis of their output voltages, similar to the battery charger utilized in FIG. 4, and were adapted to charge the battery cells in the same manner. The maximum output voltage of the battery charger in the embodiment of FIG. 6 may be 3.62 volts at 100 mA while the maximum output current may be 4.2 amperes from 3.2 volts to 3.5 volts. Meanwhile, the passive balance/bypassing current may be 120 mA and the specification of the external power source/main charger may be 15 amperes from 30 volts to 58 volts. For the experiment purpose, 16 pieces of battery cells were charged to 3.63 volts. Thereafter, the 16 pieces of battery cells were discharged by 20 ampere-hours, and then had the third battery cell in the battery pack of the 16 pieces of serial cells charged by 5 ampere-hours, i.e. 15 ampere charged for 20 minutes. As shown in FIG. 6, the status of the first battery group to the fourth battery is illustrated (cells 1-4). In the first charging stage, an external main charger was applied with 15 ampere to activate the multiple battery chargers. At the time of 35 minutes from start, the SOC of the third battery cell, which was further charged by 5 ampere-hours, was at 86% in SOC, compared to the SOC of other battery cells, which were not charged after being previously discharged, were at 68% in SOC. Despite the battery charger for the third battery was aware of lowing the corresponding charging current as the rising of the cell voltage of the third battery, the output current of the external battery charger may remain at 15 amperes due to the output voltage of the external battery charger still stayed in the range of 54.2 volts to 54.7 volts. Further, because of the high impedance of the lithium iron phosphate battery at its last charging stage of the battery cell, the rapid rise of the cell voltage of the third battery cell still triggered the cell voltage/temperature and bypassing module, and then forced the battery protection to cut off the external power source/main charger. Therefore, the multiple battery chargers, which were labeled as the equalization chargers, need to take over the following charging state until the last battery cell reaching the charging target. Accordingly, the battery charging period for the entire battery pack may last for more than two hours.

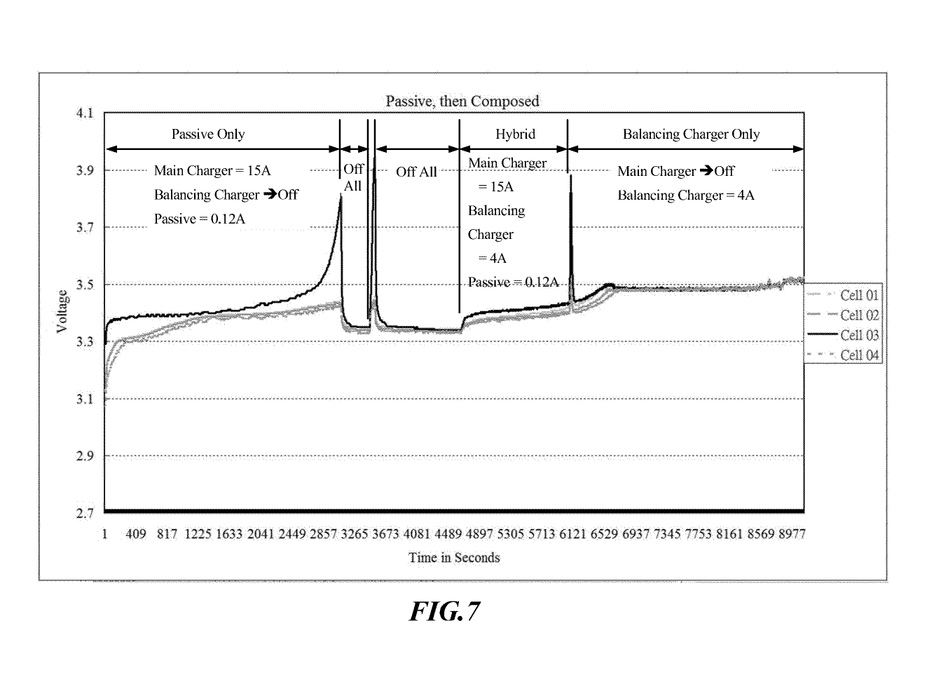

FIG. 7 shows another experiment result of the system shown in FIG. 5 according to one embodiment of the instant disclosure. One difference between the experiment result in FIG. 7 and the one in FIG. 6 is the use of the traditional bypassing balancing approach in the first stage of FIG. 7. As previously mentioned, SOC of the third battery cell was larger than other 15 pieces of battery cells by 5 ampere-hours and such difference in SOC was not compensated by one single charging, which generally wrapped up within 2 hours. However, the bypassing equalizer, before the battery chargers officially starts, detected the cell voltage of the third battery was larger than others' cell voltage, and such detection caused the passive balancing to take place. Thus, the rapid rise in the cell voltage of the third battery happened after the charging of 11.9 ampere-hours, at which point the SOC of the third battery reached 90%. Even the hybrid equalizing mode was activated when the third battery cell was reaching 90% in SOC, the rise in the total voltage due to the charging of the third battery cell did not stop the large charging current received from the external power source/main charger till the cell voltage of the third battery trigged the over-voltage protection, and the main control processor cut off the external power source/main charger. Therefore, the multiple battery charger adapted for equally charging was turned to the only current source for finishing the whole battery pack. It should be noted that the whole battery pack reached the balanced status much faster than simply multiple battery chargers mode did, even the composed mode only was activated for 21 minutes.

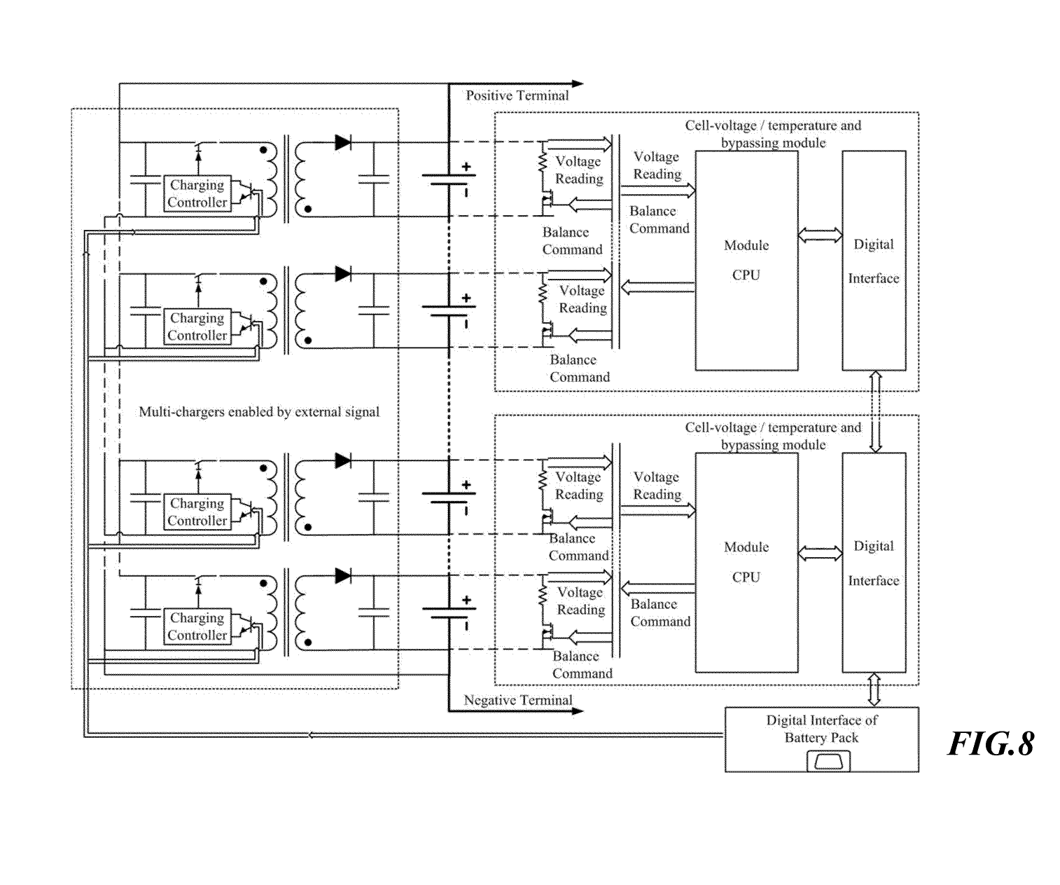

FIG. 8 shows another system according to one embodiment of the instant disclosure. The embodiment in FIG. 8 illustrates a hybrid battery balancing scheme including multiple battery chargers. Unlike the embodiment in FIG. 5, a direct current (DC) power comes from an external charger outside the battery pack, and no external AC power source is used for simplifying the design of the external wiring of the battery pack. Thus, the battery chargers are only in operation when the external main charger is activated, and a current capacity of the external main charger is greater than current capacities of the battery chargers. Since a current capacity of the external charger is greater than the current capacities of those multiple battery chargers, the power of the multiple battery chargers are not supplied by the battery cells, eliminating the possibility of the battery discharging because of the SOC difference among the battery cells, extending the service life-cycles of the batteries.

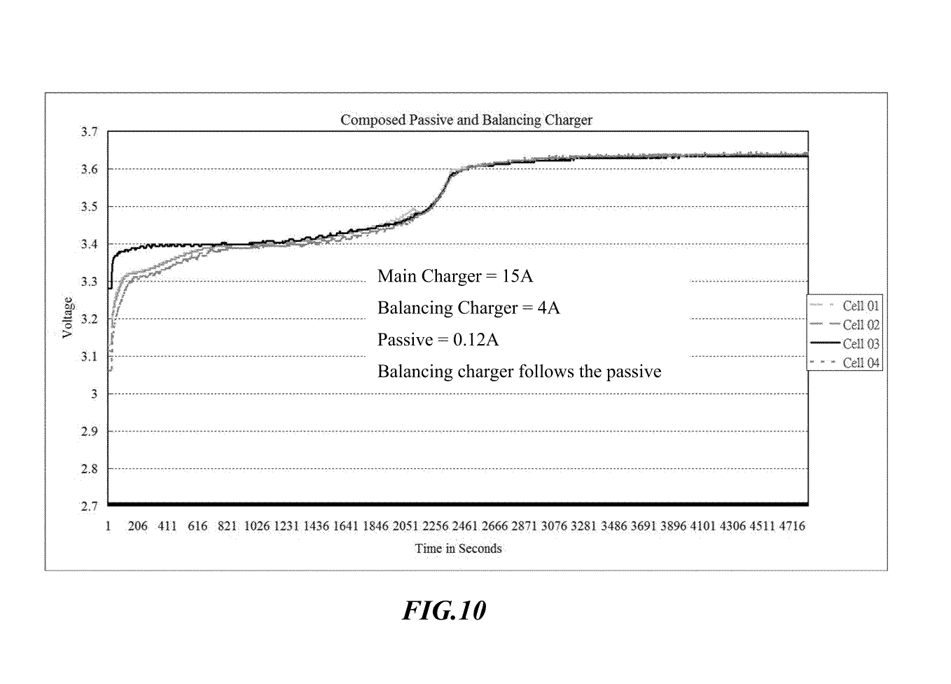

Since the DC power for the multiple battery chargers come from the external main charger, the charging current for the battery cell with the larger SOC will be reduced, therefore effectively preventing the cell voltage of such battery cells from increasing. In the second embodiment, the main control processor is configured to control/coordinate the charging of the multiple battery chargers as well. Therefore, the second embodiment is not only capable of functioning as the previous embodiment, but also to allow the charging current of the battery chargers connected to those battery cells with higher cell-voltage to be zero. As the second embodiment works in a hybrid balancing mode, the battery chargers connected battery cells with activated bypassing equalizer may stop output current, and its experiment result will be same as the result shown in FIG. 10.

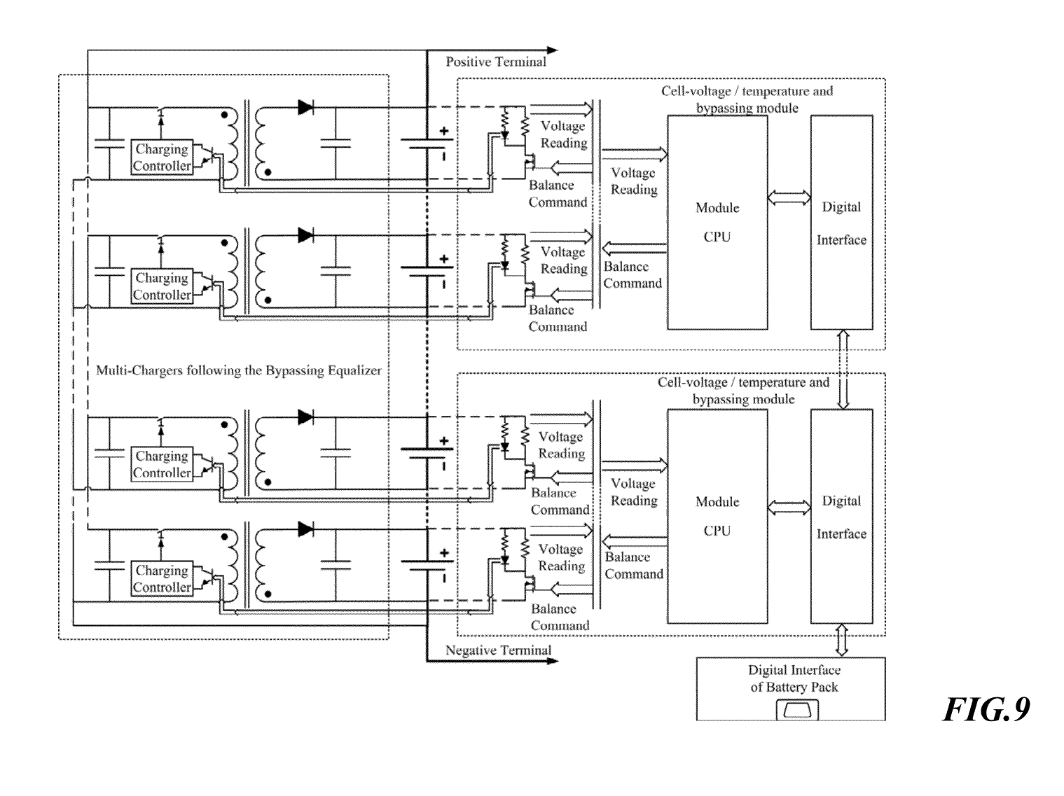

FIG. 9 illustrates another system according to one embodiment of the instant disclosure. The system in FIG. 9 includes multiple battery chargers controlled by a photo coupler. The system also includes the bypassing equalizers for controlling the charging of the battery chargers for simplifying the balancing mechanism provided by the main control processor and effectively resulting in dynamic balancing chargers. The multiple battery chargers used in this embodiment could be constant current charger to continuous voltage (CC-CV) chargers. Thus, when the cell-voltage/temperature and bypassing module activates the bypassing current, the operation of the corresponding battery charger will be suspended, significantly increasing the amount of the current at the disposal of the bypassing equalizer. Moreover, the battery cell with the lesser SOC will be charged by the larger equivalent charging current compared to the battery cell with the larger SOC, which may be charged by the lesser equivalent charging current. Thus the less charging current for those cells with higher cell-voltage or larger SOC is not only because of activated bypassing circuitry but also the suspension of battery charger. Since the electrical energy of those multiple battery chargers also come from the external main charger, the suspension of some battery chargers is equivalent to bypass much current for those cells with larger SOC. Consequently, the battery cells with the lesser SOC could be supplied with the electrical energy more promptly. Further, those multiple battery chargers work in the reverse function of the bypassing equalizer, i.e. the bypassing equalizer turns on bypassing switch, which will cause its corresponding multiple battery chargers to stop sending the output current to their corresponding battery cells. Therefore, the cut-down charging current for those cells with higher cell-voltage or larger SOC will equal to the bypassing current and the expected output current of the battery charger. Alternatively, the battery chargers under such embodiment will equal to the alternative bypassing circuitry with much higher current capacity but much lower power dissipation.

One advantage of this embodiment is the modularized bypassing equalizer, which may be fully integrated with the multiple battery chargers. Since the charging current coming from the external main charger pass through all of cell-groups, and the active equalizer is theoretically much lower dissipation, one of major disadvantage of simple cell-level active equalizer is not able to adjust the SOC difference between cell-groups. In the hybrid system with the modularized bypassing equalizer, excessive heat associated with modular bypassing equalizer could be effectively avoided, and the difference in SOC between the battery cell-groups could be accommodated and adjusted by the bypassing equalizer. It is worth noting that the battery chargers in this embodiment are powered by the external power source.

The embodiment as shown in FIG. 9 also incorporates 16 pieces of battery cells connected in the cascaded serial manner, with SOC of each of the battery cells around 28.8 Ah (±2%). Further, the multiple battery chargers used in the same system embodiment may be also capable of adjusting their output currents based on their output voltages, and the battery chargers used in this embodiment are similar to the battery chargers employed in the embodiment of FIG. 4. In certain embodiments, the maximum output voltage of the battery charger is 3.62 Volts at 100 mA and the maximum output current is 4.2 amperes at the range between 3.23.5 volts and the passive balance current is 120 mA. The specification of the external main charger is 15 amperes at the range of 30-58 volts. Similarly, the 16 pieces of serial battery cells may be charged by the battery charger to 3.62 volts and the output current thereof may be caused to be less than 200 mA. Before the experiment for the system in this embodiment is conducted, all of the 16 battery cells may be further discharged by 20 ampere-hours, before the third battery cell is charged by 5 ampere-hours or 15 amperes for 20 minutes. FIG. 10 shows the experiment result of the embodiment in FIG. 9. Since the hybrid battery balancing circuit somewhat curbs the charging of the third battery cell while imposing no such limitation on other 15 battery cells, SOC of the battery cells other than the third one may be effectively recovered. Also, because the charging current required for the charging of the third battery cell is less than other charging currents for the remaining 15 pieces of other battery cells by 4.2 amperes, the increase/rise slope of the cell voltage of the third battery cell may not be as much as those of other battery cells. Accordingly, the balance of the cell voltages of the battery cells in the same battery pack may be reached in about 38 minutes, when the charging of the whole battery pack may be accomplished in about 58 minutes.

The hybrid battery balancing system of the instant disclosure compared with other conventional arts possesses at least the following advantages: (1) employing multiple independent battery chargers capable of adjusting their output currents according to their output voltages, with such adjustable output currents supplied to the battery cells depending on their cell voltages and SOC, which enhances the adjustability of the charging currents required for the bypassing equalizer to curb the rising cell-voltage; (2) lesser cost associated with the preparation of those multiple battery chargers compared with that in the conventional multiple battery chargers applied in the active equalizer with much smaller current capacity required; and (3) eliminating the need of extracting the electrical energy from the battery cells with larger SOC to compensate the battery cells with smaller SOC, which results in frequently charging and discharging, having been identified as one drawback in the conventional active equalizer, and therefore further eliminating the rapid charging/discharging that could shorten the service life-cycles of the battery cells.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A hybrid battery balancing system coupled to a battery pack protection system having a main control processor, the battery balancing system comprising:
a cell voltage/temperature and bypassing module, comprising a cell-voltage and temperature module and a plurality of bypassing equalizers built within the cell voltage and temperature module, the cell voltage/temperature and bypassing module being configured to:
read cell voltage and temperature information;
upload the cell voltage and temperature information to the main control processor; and
receive a balance instruction from the main control processor to control a bypass current for facilitating a passive control, wherein the main control processor is configured to generate the balance instruction based on the uploaded cell voltage and temperature information and return the balance instruction to the cell voltage/temperature and bypassing module;
a plurality of battery chargers coupled to the cell voltage/temperature and bypassing module; and
a battery pack with a plurality of battery cells in serial connection and connected between the battery chargers and the cell-voltage/temperature and bypassing module in a cascaded manner, wherein each of the battery cells is one-by-one connected to and corresponds to one of the battery chargers and one of the bypassing equalizers, such that each of the battery cells is charged by the corresponding battery charger.

2. The hybrid battery balancing system according to claim 1, wherein:
an output current of each of the battery chargers is adjusted based on the output voltage of the battery charger;
the battery chargers are powered by an external main charger or alternating current (AC) source and not by electrical energy from the battery cells; and
the battery chargers are configured to provide currents required for balancing a state of charge (SOC) of the battery cells.

3. The hybrid battery balancing system according to claim 2, wherein the battery chargers comprise a plurality of independent chargers, and are configured to be activated by the main control processor.

4. The hybrid battery balancing system according to claim 2, wherein each of the battery chargers is configured to be operated by the cell voltage/temperature and bypassing module to provide a reverse function of the corresponding bypassing equalizer, and to stop the corresponding battery cell when the corresponding bypassing equalizer turns on a bypassing switch.

5. The hybrid battery balancing system according to claim 2, wherein the battery chargers are only in operation when the external main charger is activated, and a current capacity of the external main charger is greater than current capacities of the battery chargers.

6. The hybrid battery balancing system according to claim 2, wherein for each of the battery chargers, an output current is limited to be smaller than a maximum current, and a charging voltage for the battery cell corresponding to the battery charger is greater than a rated charging voltage.
